(19) United States
(12) Patent Application Publication
(10) Pub. No.: US 2026/0095756 A1
(43) Pub. Date: Apr. 2, 2026

(54) Device Sharing Using Virtual Bluetooth Classic MAC Addresses

(71) Applicant: Apple Inc., Cupertino, CA (US)

(72) Inventors: Rahul Sarna, Sunnyvale, CA (US); Akshay Mangalam Srivatsa, San Jose, CA (US); Anjali S Sandesara, Sunnyvale, CA (US); Chen Ganir, San Jose, CA (US); Duy N Phan, Los Gatos, CA (US); Karan Sawhney, San Jose, CA (US); Rohit Suresh, Fremont, CA (US); Yilok L Wong, San Diego, CA (US)

(21) Appl. No.: 19/113,393

(22) PCT Filed: Sep. 19, 2023
(86) PCT No.: PCT/US2023/033183

§ 371 Date: Mar. 19, 2025

Related U.S. Application Data
(60) Provisional application No. 63/408,192, filed on Sep. 20, 2022.

(51) Int. Cl. H04W 8/26; H04W 4/80; H04W 8/00; H04W 12/50; H04W 12/71

(52) U.S. Cl. CPC H04W 8/265; H04W 4/80; H04W 8/005; H04W 12/50; H04W 12/71

(57) ABSTRACT

An electronic device that includes an interface circuit that communicates using a Bluetooth classic communication protocol is described, where the interface circuit supports multiple independent virtual Bluetooth classic MAC addresses associated with different users or different user profiles. During operation, the interface circuit may communicate a message with a second electronic device, where the message is compatible with the Bluetooth classic communication protocol and includes a virtual Bluetooth classic MAC address associated with a user or a user profile. Moreover, when the user or the user profile signs out of the electronic device and a second user or a second user profile signs into the electronic device, the interface circuit may communicate a subsequent message using a second (different) virtual Bluetooth classic MAC address associated with the second user or the second user profile.

### FIELD

The described embodiments relate, generally, to wireless communications among electronic devices, including techniques for sharing an electronic device using virtual Bluetooth (BT) classic media access control (MAC) addresses.

### BACKGROUND

Many electronic devices communicate with each other using wireless communication protocols. For example, an electronic device can pair with and communicate with a second electronic device using a wireless personal area network (WPAN) according to a WPAN communication protocol, such as those standardized by the Bluetooth Special Interest Group (of Kirkland, Washington) and/or those developed by Apple (in Cupertino, California) that are referred to as an Apple Wireless Direct Link (AWDL). Note that the WPAN communication protocols standardized by the Bluetooth Special Interest Group include Bluetooth (BT) classic (which is sometimes referred to as ‘Bluetooth’ or ‘Bluetooth Basic Rate/Enhanced Data Rate or BR/EDR). Bluetooth classic is a WPAN communication protocol that streams data over 79 channels in the 2.4 GHz unlicensed industrial, scientific, and medical (ISM) frequency band.

However, it is typically difficult for multiple users to independently pair and use an electronic device that communicates using Bluetooth classic while ensuring their privacy. Notably, allowing multiple users to share a common MAC address of the electronic device when communicating packets or frames using Bluetooth classic raises numerous privacy and security concerns.

### SUMMARY

An electronic device that implements multiple independent virtual Bluetooth classic MAC addresses is described. This electronic device includes an interface circuit that communicates using a Bluetooth classic communication protocol, where the interface circuit supports the multiple independent virtual Bluetooth classic MAC addresses. Two or more of the independent virtual Bluetooth classic MAC addresses are associated with different users or different user profiles. During operation, the interface circuit communicates a packet or a frame (which is sometimes referred to as a ‘message’) with a second electronic device, where the packet or the frame is compatible with the Bluetooth classic communication protocol and includes a virtual Bluetooth classic MAC address (which is one of the virtual Bluetooth classic MAC addresses) associated with a user (who is one of the users) or a user profile (which is one of the user profiles).

Note that, while the user or the user profile is signed into the electronic device, the interface circuit may communicate packets or frames solely using the virtual Bluetooth classic MAC address associated with that user or user profile. Consequently, a virtual Bluetooth classic MAC address may be associated with a particular user or user profile, and is used when that user or user profile is active on the electronic device.

Moreover, when the user or the user profile signs out of the electronic device, the interface circuit may stop using the virtual Bluetooth classic MAC address. Then, when a second user or a second user profile signs into the electronic device, the interface circuit may communicate a second (subsequent) packet or frame using a second, different virtual Bluetooth classic MAC address of the virtual Bluetooth classic MAC addresses that are associated with the second user or the second user profile. The second virtual Bluetooth classic MAC address may be associated with the second user or the second user profile.

Furthermore, when a new user that is not included in the users or a new user profile that is not included in the user profiles signs into the electronic device, the electronic device may: associate a new virtual Bluetooth classic MAC address with the new user or the new user profile; and may provide, addressed to a computer (such as a cloud-based computer or computer system), information specifying that the new virtual Bluetooth classic MAC address is associated with the new user or the new user profile. Note that the new virtual Bluetooth classic MAC address may be assigned by software executed by a processor in the electronic device or by a Bluetooth controller in the electronic device. In some embodiments, the new virtual Bluetooth classic MAC address may be used with multiple electronic devices associated with the new user or the new user profile.

Additionally, the interface circuit may support discovery using virtual Bluetooth classic MAC addresses. For example, the interface circuit may support discovery using different virtual Bluetooth classic MAC addresses at different times using, e.g., time-division multiplexing of the supported virtual Bluetooth classic MAC addresses.

In some embodiments, a configuration, or one or more capabilities, of the electronic device may be personalized based at least in part on the user or the user profile. Alternatively, the configuration or the one or more capabilities of the electronic device may be generic, or shared, for at least some of the users or at least some of the user profiles.

Moreover, when the user or the user profile signs out of the electronic device, the interface circuit may revert to communicating a subsequent packet or frame using a hardware Bluetooth classic MAC address of the electronic device. Note that the hardware Bluetooth classic MAC address may be associated with the electronic device, instead of a user or user profile.

Furthermore, the electronic device may solely allow pairing with electronic devices specified in a list of allowed electronic devices. In some implementations, a given user or a given user profile may have an associated list of allowed electronic devices.

Additionally, the interface circuit may use the virtual Bluetooth classic MAC address associated with the active user or active user profile when pairing with the second electronic device. Alternatively, the interface circuit may use the hardware Bluetooth classic MAC address of the electronic device when pairing with the second electronic device.

In some embodiments, the virtual Bluetooth classic MAC address may be associated with two or more of the users or two or more of the user profiles, and the interface circuit may concurrently pair with and communicate using the virtual Bluetooth classic MAC address with electronic devices associated with either or both of two or more users or the two or more user profiles, who concurrently share the electronic device.

Note that the virtual Bluetooth classic MAC address may be different from the hardware Bluetooth classic MAC address of the electronic device.

Other embodiments provide the second electronic device that performs counterpart operations to at least some of the operations performed by the electronic device.

Other embodiments provide the computer that performs counterpart operations to at least some of the operations performed by the electronic device.

Other embodiments provide an integrated circuit for use with the electronic device or the second electronic device. The integrated circuit may perform at least some of the aforementioned operations.

Other embodiments provide a computer-readable storage medium for use with the electronic device, the second electronic device or the computer. When program instructions stored in the computer-readable storage medium are executed by the electronic device, the second electronic device or the computer, the program instructions may cause the electronic device, the second electronic device or the computer to perform at least some of the aforementioned operations of the electronic device, the second electronic device or the computer.

Other embodiments provide a method that includes at least some of the aforementioned operations performed by the electronic device, the second electronic device, or the computer.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates an example of communication between electronic devices according to some embodiments of the disclosure.

FIG. 2 illustrates an example method for communicating a packet or a frame using a virtual Bluetooth classic MAC address according to some embodiments of the disclosure.

FIG. 3 illustrates an example of communication among components, e.g., in the electronic devices of FIG. 1 according to some embodiments of the disclosure.

FIGS. 4A and 4B illustrate an example of communication among the electronic devices of FIG. 1 according to some embodiments of the disclosure.

FIGS. 5A and 5B illustrate an example of communication among the electronic devices of FIG. 1 according to some embodiments of the disclosure.

FIG. 6 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

Some embodiments include an electronic device configured with multiple independent virtual Bluetooth classic MAC addresses. This electronic device may include an interface circuit that communicates using a Bluetooth classic communication protocol, where the interface circuit supports the multiple independent virtual Bluetooth classic MAC addresses. Furthermore, different virtual Bluetooth classic MAC addresses configured on the device may be associated with different users or different user profiles. During operation, the interface circuit may communicate a packet or a frame with a second electronic device, where the packet or the frame is compatible with the Bluetooth classic communication protocol and includes a virtual Bluetooth classic MAC address (which is one of the virtual Bluetooth classic MAC addresses) associated with a user (who is one of the users) or a user profile (which is one of the user profiles). Note that the virtual Bluetooth classic MAC address may be different from a hardware Bluetooth classic MAC address of the electronic device. Moreover, when the user or the user profile signs out of the electronic device, the interface circuit may stop using the virtual Bluetooth classic MAC address. Then, when a second user or a second user profile signs into the electronic device, the interface circuit may communicate a subsequent packet or frame using a second, different virtual Bluetooth classic MAC address associated with the second user or the second user profile. Note that the second virtual Bluetooth classic MAC address may be retrieved from a stored set of virtual Bluetooth classic MAC addresses associated with users or user accounts configured on the electronic device.

By configuring the electronic device to use different independent virtual Bluetooth classic MAC addresses for different users or user profiles, the different users or users profiles may be allowed to share the electronic device (e.g., at different times). Furthermore, the different independent virtual Bluetooth classic MAC addresses may allow the experience of using the electronic device to be personalized or customized for a given user or user profile. Notably, the communication techniques described herein may provide flexible, convenient, private and secure communication, using the electronic device, by the different users or user profiles. Consequently, the communication techniques may improve the user experience when using the electronic device.

In the discussion that follows, a user may include: an individual, an organization, a company, a governmental agency, a for-profit business entity, a not-for-profit entity, or a group of one or more individuals.

Note that the communication techniques may be used during or with wired or wireless communication between electronic devices in accordance with a communication protocol, such as a communication protocol that is compatible with a Bluetooth classic standard. However, this communication techniques may also be used with a wide variety of other communication protocols, and in electronic devices (such as portable electronic devices or mobile devices) that can incorporate multiple different radio access technologies (RATs) to provide connections through different wireless networks that offer different services and/or capabilities, such as a communication protocol that is compatible with an IEEE 802.11 standard (which is sometimes referred to as Wi-Fi).

Thus, an electronic device can include hardware and software to support a WPAN according to a WPAN communication protocol, such as those standardized by the Bluetooth Special Interest Group and/or those developed by Apple (in Cupertino, California), e.g., referred to as an AWDL. More generally, the electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, or other present or future developed IEEE 802.11 technologies.

Note that the electronic device may use multi-user transmission (such as OFDMA) and/or multiple-input multiple-output (MIMO).

In some embodiments, the electronic device can act as a communications hub that provides access to a WLAN and/or to a WWAN and, thus, to a wide variety of services that can be supported by various applications executing on the electronic device. Thus, the electronic device may include an ‘access point’ that communicates wirelessly with other electronic devices (such as using Wi-Fi), and that provides access to another network (such as the Internet) via IEEE 802.3 (which is sometimes referred to as ‘Ethernet'). Note that the access point may be a physical access point or a virtual or 'software’ access point that is implemented on a computer or an electronic device. However, in other embodiments the electronic device may not be an access point.

Additionally, it should be understood that the electronic devices described herein may be configured as multi-mode wireless communication devices that are also capable of communicating via different 3G RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein may be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) may be used herein to describe one or more consumer electronic devices that may be capable of performing procedures associated with various embodiments of the disclosure.

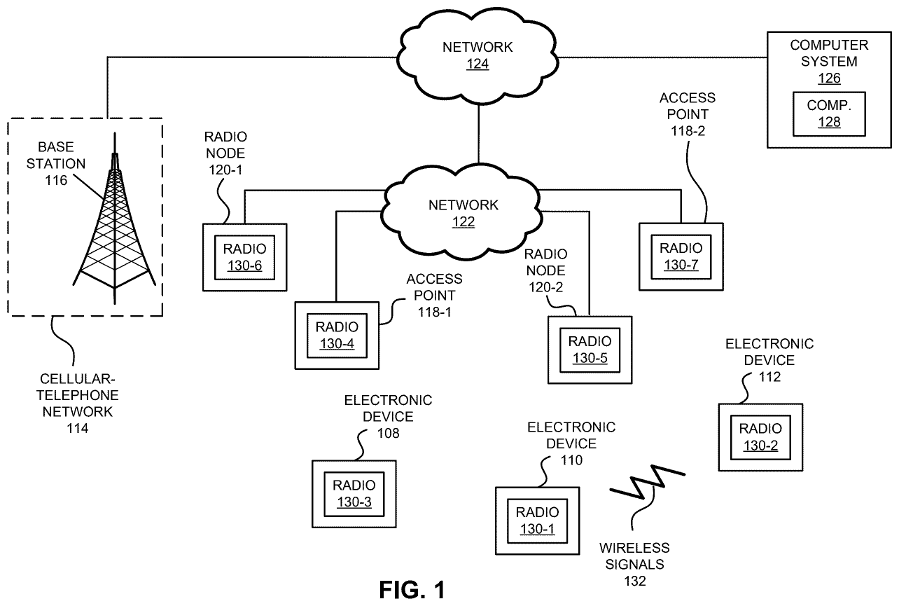

FIG. 1 presents a block diagram illustrating an example of electronic devices that communicate using wired and/or wireless communication. Notably, electronic device 110 (such as a smartphone, a laptop computer, a notebook computer, a tablet, or another such electronic device) and electronic device 112 (such as another smartphone, another laptop computer, another notebook computer, another tablet, one or more speakers, headphones, a keyboard, a mouse, a printer, another type of peripheral device, or another electronic device) may perform discovery (e.g., electronic device 110 may discover electronic device 112) and may perform pairing, e.g., by establishing a Bluetooth classic connection with each other.

Moreover, electronic device 110 may communicate, using wired and/or wireless communication, with one or more electronic devices (such as electronic device 112) and/or one or more computers, such as computer 128 in computer system 126. For example, after pairing, electronic device 110 may communicate one or more packets or frames with electronic device 112 using a Bluetooth classic communication protocol (or a communication protocol that is compatible with a Bluetooth classic standard).

More generally, communication in FIG. 1 may occur: directly (such as when electronic device 110 is within wireless range of another electronic device, such as electronic device 112), or via a network, such as a cellular-telephone network 114 (which may include a base station 116), one or more access points 118 (which may communicate using Wi-Fi) in a WLAN and/or one or more radio nodes 120 (which may communicate using LTE or a 5G cellular-telephone communication protocol) in a small-scale network (such as a small cell). For example, the one or more radio nodes 120 may include: an Evolved Node B (eNodeB), a Universal Mobile Telecommunications System (UMTS) NodeB and radio network controller (RNC), a New Radio (NR) gNB or gNodeB, etc. Note that one or more base stations (such as base station 116), access points 118, and/or radio nodes 120 may be included in one or more wireless networks, such as: a WLAN, a small cell, and/or a macro cellular-telephone network.

Access points 118 and/or radio nodes 120 may communicate with each other and/or computer system 126 (which may be a local or a cloud-based computer system that includes one or more computer, such as computer 128) using a wired communication protocol (such as Ethernet) via network 122 and/or 124. However, in some embodiments, access points 118 and/or radio nodes 120 may communicate with each other using wireless communication (such as Wi-Fi, Bluetooth classic and/or another wireless communication protocols), e.g., one of access points 118 may be a mesh access point in a mesh network. Note that networks 122 and 124 may be the same or different networks. For example, networks 122 and/or 124 may an LAN, an intra-net or the Internet.

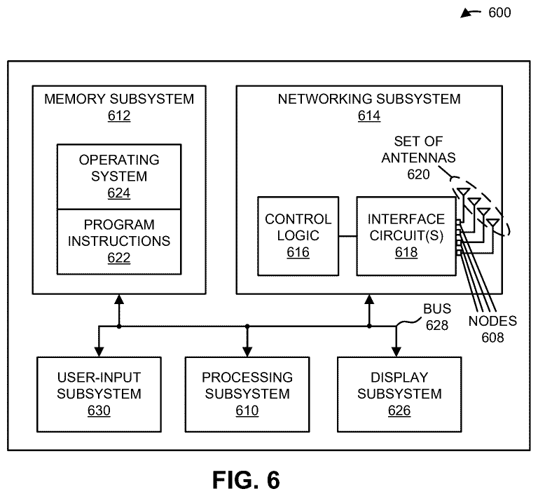

As described further below with reference to FIG. 6, electronic device 108, electronic device 110, electronic device 112 and computer system 126 may include subsystems, such as a networking subsystem, a memory subsystem, and a processor subsystem. In addition, electronic device 108, electronic device 110, electronic device 112, access points 118 and radio nodes 120 may include radios 130 in the networking subsystems. More generally, electronic device 108, electronic device 110, electronic device 112, access points 118 and radio nodes 120 can include (or can be included within) any electronic devices with networking subsystems that enable electronic device 108, electronic device 110, electronic device 112, access points 118 and radio nodes 120, respectively, to wirelessly communicate with another electronic device. This can include transmitting frames or beacons on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

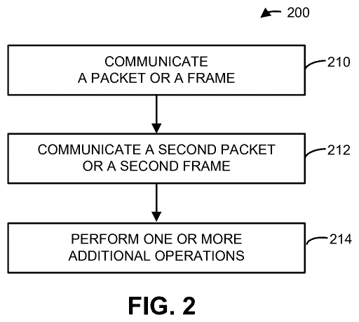

As can be seen in FIG. 1, wireless signals 132 (represented by a jagged line) are communicated by one or more radios 130-1 and 130-2 in electronic device 110 and electronic device 114, respectively. For example, electronic device 110 and electronic device 114 may exchange packets or frames using a Bluetooth classic protocol. Moreover, as illustrated further below with reference to FIGS. 2-5B, one or more radios 130-1 may receive wireless signals 132 that are transmitted by one or more radios 130-2 via one or more connections between electronic device 110 and electronic device 112. Alternatively, the one or more radios 130-1 may transmit wireless signals 132 that are received by the one or more radios 130-2. The wireless signals 132 may convey one or more packets or frames.

During the communication in FIG. 1, electronic device 108, electronic device 110, electronic device 112, access points 118 and radio nodes 120 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include additional information, such as data, as payloads).

As discussed previously, it can be difficult for multiple users (such as a user of electronic device 110 and a second user of electronic device 108) to share an electronic device (such as electronic device 112) while maintaining security and privacy. In order to address these challenges, as described below with reference to FIGS. 2-5B, in some embodiments of the disclosed communication techniques an interface circuit in electronic device 112 may support multiple independent virtual Bluetooth classic MAC addresses. Two or more of the independent virtual Bluetooth classic MAC addresses may be associated with different users or different user profiles (such as user profiles associated with accounts of the different users). Notably, during operation, the interface circuit may communicate one or more packets or frames with electronic device 110, where the one or more packets or frames are compatible with the Bluetooth classic communication protocol and include a virtual Bluetooth classic MAC address (which is one of the virtual Bluetooth classic MAC addresses) associated with a user (who is one of the users) or a user profile (which is one of the user profiles). While the user or the user profile is signed into electronic device 112 (or active), the interface circuit may communicate packets or frames using the virtual Bluetooth classic MAC address associated with that user or user profile associated with that user or user profile. Consequently, a virtual Bluetooth classic MAC address may be associated with a particular user or user profile, and is used when that user or user profile is active on electronic device 112.

Moreover, when the user or user profile signs out of electronic device 112, the interface circuit may stop using the virtual Bluetooth classic MAC address associated with that user or user profile. The interface circuit may revert to communicating one or more subsequent packets or frames using a different Bluetooth MAC address, such as a hardware Bluetooth classic MAC address associated with electronic device 112 or a default virtual Bluetooth classic MAC address associated with electronic device 112. Furthermore, the virtual Bluetooth classic MAC address may be different from a default address, such as the hardware Bluetooth classic MAC address of the electronic device and the default virtual Bluetooth classic MAC address associated with electronic device 112.

Additionally, when the second user or second user profile (such as the second user or the second user profile associated with electronic device 108) signs into electronic device 112, the interface circuit may communicate subsequent packets or frames using a second, different virtual Bluetooth classic MAC address associated with the second user. Electronic device 112 may maintain a set of virtual Bluetooth classic MAC addresses associated with corresponding users or user profiles configured on electronic device 112.

However, when the second user is a new user/user profile that is not already associated with a corresponding virtual Bluetooth classic MAC address, electronic device 112 may: associate a new virtual Bluetooth classic MAC address with the new user/user profile; and may provide, addressed to computer 128 or computer system 126, information specifying that the new virtual Bluetooth classic MAC address is associated with the new user/user profile. Note that the new virtual Bluetooth classic MAC address may be assigned by software executed by a processor in electronic device 112 (and, thus, by a host in electronic device 112) or by a Bluetooth controller in electronic device 112. In some embodiments, the new virtual Bluetooth classic MAC address may be used with multiple electronic devices associated with the new user/user profile. Notably, computer 128 or computer system 126 may disseminate, via networks 112 and 114, the new virtual Bluetooth classic MAC address to the multiple electronic devices associated with the new user/user profile. Then, when the new user/user profile is used to log into another electronic device of the multiple electronic devices, the other electronic device may use, for communications, the new virtual Bluetooth classic MAC address associated with the new user/user profile. This capability may allow the multiple electronic devices associated with the new user/user profile to connect more easily with each other.

In some embodiments, the interface circuit may support discovery using virtual Bluetooth classic MAC addresses. For example, the interface circuit may support discovery using different virtual Bluetooth classic MAC addresses, of the supported virtual Bluetooth classic MAC addresses, at different times using, e.g., time-division multiplexing. Thus, the interface circuit may communicate a packet or a frame that includes the virtual Bluetooth classic MAC address during a time interval (such as 1-10 s) and then may communicate a second (subsequent) packet or a second frame that includes the second virtual Bluetooth classic MAC address during a second time interval (such as 1-10 s, and which may be the same as or different from the time interval).

Moreover, the interface circuit may use the virtual Bluetooth classic MAC address associated with the active user or active user profile when pairing with electronic device 110. This approach may be solely used when the user or the user profile signs in and uses electronic device 112. Alternatively, the interface circuit may use the hardware Bluetooth classic MAC address associated with electronic device 112 when pairing with electronic device 110. This other approach may be used when multiple users or user profiles are used to sign in and use electronic device 112.

Furthermore, in some embodiments, a configuration, or one or more capabilities, of electronic device 112 may be personalized based at least in part on the user or the user profile. For example, after the user or the user profile signs into electronic device 112, the configuration or the one or more capabilities of electronic device 112 may be personalized to the preferences, values, settings, etc., of the user or user profile. In some embodiments, the configuration or the one or more capabilities of electronic device 112 may include generic, shared or common aspects that are the same for at least some of the users or the user profiles configured on electronic device 112.

Additionally, in some embodiments, electronic device 112 may solely allow pairing with electronic devices specified in a list of allowed electronic devices, such as a list of allowed electronic devices associated with the active user or the user profile (and, more generally, with a given user or a given user profile). When one of the electronic devices in the list of allowed electronic devices attempts to pair with electronic device 112, the pairing may be allowed. However, a pairing attempt involving an electronic device that is not included in the list of allowed electronic devices may not be allowed. The list of allowed electronic devices (e.g., for a particular user or user profile) may be communicated to electronic device 112 by computer system 126 or computer 128, e.g., via networks 112 and 114. Alternatively or additionally, the list of allowed electronic devices for the particular user or the particular user profile may be communicated by the particular user or user profile (e.g., by electronic device 110) when the user or the user profile signs into electronic device 112.

In some embodiments, electronic device 112 may solely allow pairing with electronic devices (and, thus, the providing of Bluetooth services) based at least on a current user or a current user profile that is active. A Bluetooth classic MAC address, a virtual Bluetooth classic MAC address and/or a list of allowed electronic devices (or a list of denied electronic devices) that is associated with the current active user or the current active user profile are optional techniques for implemented the selective pairing with electronic device 112. Therefore, in some embodiments, the selective pairing with electronic device 112 may be implemented using one or more virtual Bluetooth classic MAC addresses associated with the current active user or the current active user profile, and may not need to be used in combination with the list of allowed electronic devices (or the list of denied electronic devices). In some embodiments, the selective pairing with electronic device 112 may be implemented using the list of allowed electronic devices (or the list of denied electronic devices), which may be associated with the current active user or the current active user profile. Note that the list of allowed electronic devices includes a subset of electronic devices associated with the current active user or the current active user profile that are allowed to connect with electronic device 112, while the list of denied electronic devices is an aggregation of electronic devices for other users that should not be allowed to connect with electronic device 112 if these electronic devices do not belong to or are not associated with the current active user or the current active user profile. However, note that in a pairing mode, electronic device 112 may pair with an arbitrary electronic device, including electronic devices that are associated with other users than the current active user or the current active user profile.

While preceding discussion illustrated the use of a particular virtual Bluetooth classic MAC address by a particular user or user profile at a given time (e.g., sequential sharing of electronic device 112), in other embodiments the virtual Bluetooth classic MAC address may be associated with two or more of the users or two or more of the user profiles, and the interface circuit may concurrently pair with and communicate using the virtual Bluetooth classic MAC address with electronic devices associated with any of of two or more users or the two or more user profiles, who concurrently share electronic device 112 (e.g., at the same time).

The communication techniques may facilitate secure, private, flexible and convenient sharing of electronic device 112 by multiple users or user profiles. Moreover, the communication techniques may allow the configuration, or one or more capabilities, of electronic device 112 to be personalized to a particular user or user profile. Consequently, the communication techniques may improve the user experience when using electronic device 112.

In the described embodiments, processing a packet or a frame in electronic device 108, electronic device 110, electronic device 112, access points 118 and/or radio nodes 120 may include: receiving the wireless signals 132 with the packet or the frame; decoding/extracting the packet or the frame from the received wireless signals 132 to acquire the packet or the frame; and processing the packet or the frame to determine the information contained in the payload of the packet or the frame (such as data in the payload).

In general, the communication via the one or more connections in the communication techniques may be characterized by a variety of communication-performance metrics. For example, the communication-performance metric may include any/all of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a time interval (such as a time interval between, e.g., 1 and 10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices may be present. For example, some embodiments may include more or fewer electronic devices. As another example, in other embodiments, different electronic devices can be transmitting and/or receiving packets or frames. In some embodiments, multiple connections or links may be used during communication between an electronic device (such as electronic device 108 or electronic device 110) and electronic device 112. Moreover, while electronic device 112 performed operations in the communication techniques, in other embodiments at least some of these operations may be performed by electronic device 108, electronic device 110, computer system 126 and/or computer 128. Consequently, electronic device 108, electronic device 110, electronic device 112, computer system 126 and/or computer 128 may perform operations in the communication techniques.

Furthermore, while the preceding discussion illustrated the communication techniques using Bluetooth classic, in other embodiments the communication techniques may be used with another communication protocol, such as Bluetooth Low Energy (BLE) communication protocol or a near-field communication protocol.

FIG. 2 presents a flow diagram illustrating an example method 200 for communicating a packet or a frame using a virtual Bluetooth classic MAC address. This method may be performed by an electronic device, such as electronic device 112 in FIG. 1. For example, an interface circuit in the electronic device may support multiple independent virtual Bluetooth classic MAC addresses. Two or more of the independent virtual Bluetooth classic MAC addresses may be associated with different users or different user profiles.

During operation, the electronic device may communicate the packet or the frame (operation 210) with (to or from) a second electronic device, where the packet or the frame is compatible with a Bluetooth classic communication protocol and comprises a virtual Bluetooth classic MAC address (which is one of the virtual Bluetooth classic MAC addresses) associated with a user (who is one of the users) or a user corresponding to the electronic device. Note that the virtual Bluetooth classic MAC address may be different from a hardware Bluetooth classic MAC address of the electronic device.

While the user or the user profile is signed into the electronic device, the electronic device may communicate packets or frames solely using the virtual Bluetooth classic MAC address associated with that user or user profile. Consequently, a virtual Bluetooth classic MAC address may be associated with a particular user or user profile, and is used when that user or user profile is active on the electronic device. However, when the user or the user profile signs out of the electronic device, the electronic device may stop using the virtual Bluetooth classic MAC address. When a second user or a second user profile signs into the electronic device, the interface circuit may communicate a second (subsequent) packet or frame (operation 212) using a second, different virtual Bluetooth classic MAC address of the virtual Bluetooth classic MAC addresses. The second virtual Bluetooth classic MAC address may be associated with the second user or the second user profile.

In some embodiments, the electronic device optionally performs one or more additional operations (operation 214). For example, when a new user or a new user profile signs into the electronic device, the electronic device may: associate a new virtual Bluetooth classic MAC address with the new user/user profile; and may provide, addressed to a computer (such as a cloud-based computer or computer system), information specifying that the new virtual Bluetooth classic MAC address is associated with the new user/user profile. Note that the new virtual Bluetooth classic MAC address may be assigned by software executed by a processor in the electronic device or by a Bluetooth controller in the electronic device. In some embodiments, the new virtual Bluetooth classic MAC address may be used with multiple electronic devices associated with the new user or the new user profile.

Furthermore, the electronic device may support discovery using virtual Bluetooth classic MAC addresses. For example, the electronic device may support performing discovery using different virtual Bluetooth classic MAC addresses at different times using, e.g., time-division multiplexing of the supported virtual Bluetooth classic MAC addresses. The time allocated to each of the virtual Bluetooth classic MAC addresses in use may be equal or may be assigned unequally.

In some embodiments, one or more configurations and/or one or more capabilities of the electronic device may be personalized based at least in part on the active user or the user profile. Furthermore, in some embodiments, one or more configuration or one or more capabilities of the electronic device may be generic, shared, or common for at least some of the users or user profiles.

In some embodiments, when the user or the user profile signs out of the electronic device, the electronic device may revert to communicating a subsequent packet or frame using a hardware Bluetooth classic MAC address of the electronic device or a default virtual Bluetooth classic MAC address. Note that the hardware Bluetooth classic MAC address may be associated with the electronic device, instead of a user or user profile.

Moreover, in some embodiments, the electronic device may solely allow pairing with electronic devices specified in a list of allowed electronic devices. In some implementations, a given user or a given user profile may have an associated list of allowed electronic devices.

Furthermore, the electronic device may use the virtual Bluetooth classic MAC address associated with the active user or active user profile when pairing with the second electronic device. Alternatively, the electronic device may use the hardware Bluetooth classic MAC address of the electronic device when pairing with the second electronic device, which may be useful when multiple users or user profiles share the electronic device (e.g., at different times).

Additionally, in some embodiments, the virtual Bluetooth classic MAC address may be associated with two or more of the users or two or more of the user profiles, and the electronic device may concurrently pair with and communicate using the virtual Bluetooth classic MAC address with electronic devices associated with either or both of two or more users or the two or more user profiles, who concurrently share the electronic device (e.g., at the same time).

In some embodiments of method 200, there may be additional or fewer operations. Further, one or more different operations may be included. Moreover, the order of the operations may be changed, and/or two or more operations may be combined into a single operation or performed at least partially in parallel.

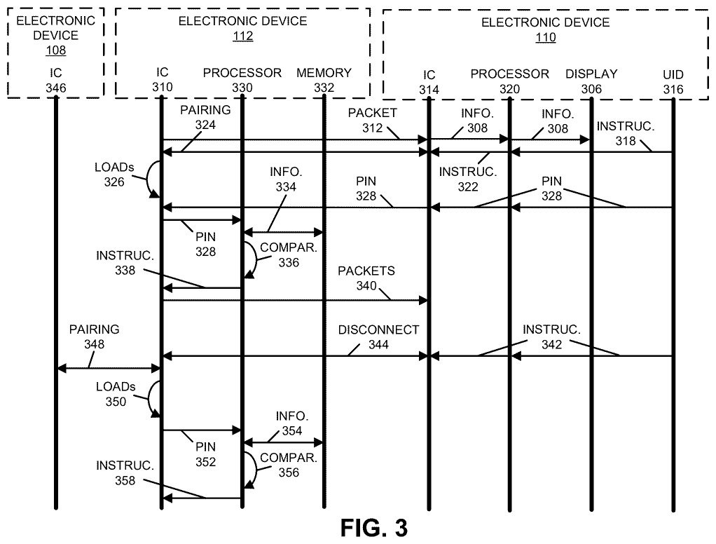

The communication techniques are further illustrated in FIG. 3, which presents a flow diagram illustrating an example of communication among components in electronic device 108, electronic device 110, electronic device 112, and computer 128. During operation, electronic device 110 may discover electronic device 112. For example, an interface circuit (IC) 310 in electronic device 112 may provide a packet 312 or a frame with information about electronic device 112 to an interface circuit 314 in electronic device 110. In embodiments where electronic device is shared (e.g., by users or user profiles associated with electronic devices 108 and 110), packet 312 may include a hardware Bluetooth classic MAC address associated with electronic device 112 (such as the hardware Bluetooth classic MAC address associated with interface circuit 310). However, in other embodiments where a single user or user profile uses electronic device 112, packet 312 may include a virtual Bluetooth classic MAC address associated with the user or the user profile. Moreover, interface circuit 314 may provide information 308 about the discovered electronic device 112 to processor 320 in electronic device 110, which may display information 308 on display 306 in electronic device 110.

Then, a user of electronic device 110 may interact with a user-interface device (UID) 316 in electronic device 110 (such as a keyboard, a mouse, a touch-sensitive display, a voice interface, etc.) to provide an instruction 318 to processor 320 to establish a pairing 324 with electronic device 112. Moreover, processor 320 may provide an instruction 322 to interface circuit 314, which establishes pairing 324 with interface circuit 310 by exchanging one or more packets or frames.

Note that during pairing 324, interface circuit 310 may determine whether it is allowed to establish pairing 324 with electronic device 110 using a list of allowed devices (LOADs) 326, which may be stored in memory in interface circuit 310. Moreover, when the initial communication with electronic device 110 used the hardware Bluetooth classic MAC address associated with electronic device 112, then, during or after pairing 324, interface circuit 310 may use the virtual Bluetooth classic MAC address associated with the user or the user profile. For example, after pairing 324, the user of electronic device 110 may interact with user-interface device 316 to provide a passcode or PIN 328 to processor 320, which instructs interface circuit 314 to provide PIN 328 to interface circuit 310. After receiving PIN 328, interface circuit 310 may provide PIN 328 to a processor 330 in electronic device 112, which logs in or signs in the user or the user profile based at least in part on a comparison 336 of PIN 328 with stored information 334 in memory 332 in electronic device 112. Moreover, after successfully signing in the user or the user profile, processor 330 may instruct 338 interface circuit 310 to use the virtual Bluetooth classic MAC address associated with the user or the user profile during subsequent communication with electronic device 112. Notably, interface circuit 310 may include the virtual Bluetooth classic MAC address in a packet or a frame (such as one of packets 340) communicated to interface circuit 314, and interface circuit 314 may include the virtual Bluetooth classic MAC address in a packet or a frame (such as one of packets 340) communicated to interface circuit 310.

Subsequently, the user of electronic device 110 may interact with user-interface device 316 to instruction 342 processor 320 to sign out and disconnect from electronic device 112. Processor 320 may provide instruction 342 to interface 314, which disconnects 344 from electronic device 112. After electronic device 110 disconnects, interface circuit 310 may revert to using the hardware Bluetooth classic MAC address during communication.

Next, interface circuit 346 in electronic device 108 may automatically establish a pairing 348 with electronic device 112. For example, interface circuit 346 may exchange one or more packets or frames with interface circuit 314, which include the hardware Bluetooth classic MAC address. Note that during pairing 348, interface circuit 310 may determine whether or not it is allowed to establish pairing 348 with electronic device 108 using a list of allowed devices 350, which may be stored in memory in interface circuit 310

Moreover, during or after pairing 348, interface circuit 346 may automatically provide log-in or sign-in information for a second user or a second user profile, such as passcode or PIN 352. After receiving PIN 352, interface circuit 310 may provide PIN 352 to processor 330 in electronic device 112, which logs in or signs in the second user or the second user profile based at least in part on a comparison 356 of PIN 352 with stored information 354 in memory 332. Moreover, after successfully signing in the second user or the second user profile, processor 330 may instruct 358 interface circuit 310 to use a second virtual Bluetooth classic MAC address associated with the second user or the second user profile (which is different from the virtual Bluetooth classic MAC address associated with the user or the user profile) during subsequent communication with electronic device 108.

While communication between the components in FIG. 3 is illustrated with unilateral or bilateral communication (e.g., lines having a single arrow or dual arrows), in general a given communication operation may be unilateral or bilateral.

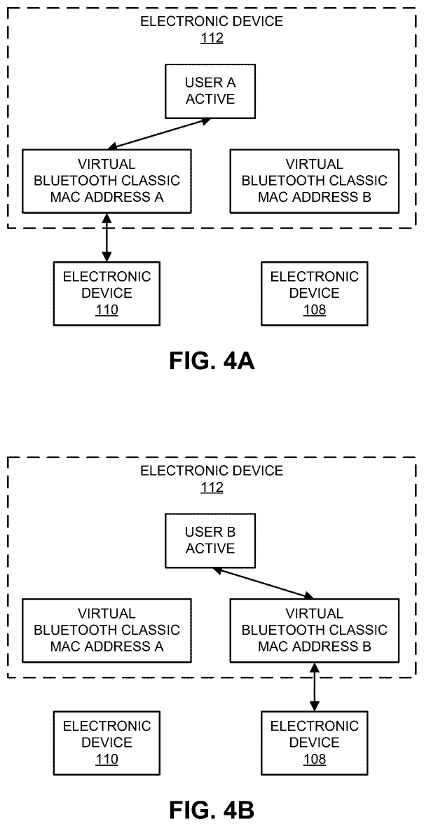

We now further discuss the communication techniques. FIGS. 4A and 4B present an example of communication among electronic devices 108, 110 and 112. Notably, when a user or a user profile associated with electronic device 110 is paired with and signed into electronic device 112, electronic devices 110 and 112 may use a virtual Bluetooth classic MAC address associated with the user or the user profile when communicating one or more packets or frames.

Subsequently, when the user or the user profile signs out and electronic device 110 disconnects from electronic device 112, electronic device 112 may revert to using a hardware Bluetooth classic MAC address when communicating one or more packets or frames.

Moreover, when a second user or a second user profile associated with electronic device 108 is paired with and signed into electronic device 112, electronic devices 108 and 112 may use a second virtual Bluetooth classic MAC address associated with the second user or the second user profile when communicating one or more packets or frames.

The communication of packets or frames by electronic device 112 that include different virtual Bluetooth classic MAC addresses when electronic device 112 is used by different users or user profiles may separate the traffic associated with the different users or user profiles, thereby providing security and privacy to the different users or user profiles, while allowing the different users or user profiles to share electronic device 112.

In some embodiments, the communication techniques allow privacy-safe Bluetooth classic pairing on a shared electronic device used by multiple users allows each user to independently pair Bluetooth electronic devices for themselves. Notably, a virtual Bluetooth classic MAC address may be assigned to each user signed into the electronic device. When user A signs into the electronic device, they may be assigned virtual Bluetooth classic MAC address A, and any Bluetooth classic pairing with user A may use the virtual Bluetooth classic MAC address A as the address for the electronic device. Moreover, when the signed in user changes to user B, the virtual Bluetooth classic MAC address may change to virtual Bluetooth classic MAC address B, and electronic devices that connect to the electronic device may no longer use the virtual Bluetooth classic MAC address A. For example, if user A is active and pairs their in-ear wireless headphones to the tablet, the pairing may use the virtual Bluetooth classic MAC address A. Alternatively, when user B is active and pairs different or the same in-ear wireless headphones to the tablet, the pairing may use the virtual Bluetooth classic MAC address B, thereby protecting the privacy of user A. This capability may also prevent user A from trying to spy on user B's activity using a malicious Bluetooth electronic device. Consequently, the independent pairings by different users in the communication techniques may help ensure privacy and security.

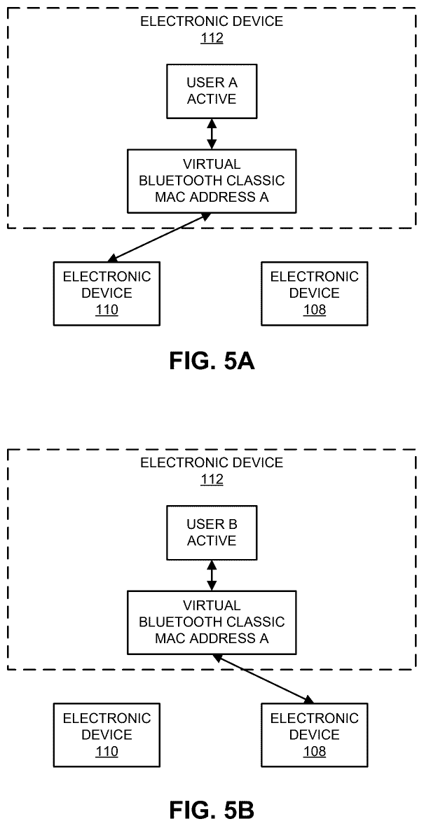

FIGS. 5A and 5B present an example of communication among electronic devices 108, 110 and 112. Notably, when electronic device 110 pairs with electronic device 112 and the user or the user profile signs into electronic device 112, a list of allowed electronic devices associated with the user or the user profile may be communicated to electronic device 112. Based at least in part on the list of allowed electronic devices, electronic device 112 may not allow electronic device 108 to connect with electronic device 112 because electronic device 108 is not included in the list of allowed electronic devices associated with the user or the user profile.

However, when electronic device 108 pairs with electronic device 112 and the second user or the second user profile signs into electronic device 112, a second list of allowed electronic devices associated with the second user or the second user profile may be communicated to electronic device 112. Based at least in part on the second list of allowed electronic devices, electronic device 112 may not allow electronic device 110 to connect with electronic device 112 because electronic device 110 is not included in the second list of allowed electronic devices associated with the second user or the second user profile.

In some embodiments of FIGS. 5A and 5B, electronic devices 108, 110 and 112 may each use the same virtual Bluetooth classic MAC address, such as virtual Bluetooth classic MAC address A. However, in some embodiments, the ability to pair or connect with electronic device 112 may be optionally gated or restricted by the current list of allowed electronic devices associated with a particular user or user profile.

These capabilities of electronic device 112 may allow different users to sign in and share a common electronic device, such as a Bluetooth keyboard. Moreover, a Bluetooth controller in electronic device 112 may determine whether a particular electronic device is shared (and, thus, may have a common or generic, or shared, configuration or capabilities) or is user-specific (and, thus, may have a personalized configuration or capabilities). In some embodiments, a discoverability MAC address of electronic device 112 may be rotated between a virtual Bluetooth classic MAC address associated with a signed-in user and a shared virtual Bluetooth classic MAC address, using, e.g., time-division multiplexing. Furthermore, the capabilities of electronic device 112 may allow concurrent sharing of electronic device 112, such as multiple users signed into and using electronic device during a common session.

Note that the formats of packets or frames communicated during the communication techniques may include more or fewer bits or fields. Alternatively or additionally, the position of information in these packets or frames may be changed. Thus, the order of the fields may be changed.

While the preceding embodiments illustrate embodiments of the communication techniques using channels or frequency sub-bands, in other embodiments the communication techniques may involve the concurrent use of different temporal slots, and/or or a combination of different frequency sub-bands, different frequency bands and/or different temporal slots.

Moreover, while the preceding embodiments illustrated the use of Bluetooth classic, a cellular-telephone communication protocol and/or Ethernet in the communication techniques, in other embodiments of the communication techniques another communication protocol (such as Wi-Fi or Bluetooth Low Energy) is used to communicate at least a portion of the information in the communication techniques. Furthermore, the information communicated in the communication techniques may be communicated may occur in one or more frequency bands, including: 900 MHz, a 2.4 GHz frequency band, a 5 GHz frequency band, a 6 GHz frequency band, a 7 GHz frequency band, a 60 GHz frequency band, a Citizens Broadband Radio Service (CBRS) frequency band, a band of frequencies used by LTE, etc.

As described herein, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 6 presents a block diagram of an electronic device 600 (which may be a cellular telephone, a smartwatch, a speaker, a keyboard, a mouse, headphones, one or more speakers, a printer, another type of peripheral device, a computer, an access point, an IoT device, another electronic device, etc.) in accordance with some embodiments. This electronic device includes processing subsystem 610, memory subsystem 612 and networking subsystem 614. Processing subsystem 610 includes one or more devices configured to perform computational operations. For example, processing subsystem 610 can include one or more microprocessors, application-specific integrated circuits (ASICs), microcontrollers, graphics processing units (GPUS), programmable-logic devices, and/or one or more digital signal processors (DSPs).

Memory subsystem 612 includes one or more devices for storing data and/or instructions for processing subsystem 610, and/or networking subsystem 614. For example, memory subsystem 612 can include dynamic random access memory (DRAM), static random access memory (SRAM), a read-only memory (ROM), flash memory, and/or other types of memory. In some embodiments, instructions for processing subsystem 610 in memory subsystem 612 include: program instructions or sets of instructions (such as program instructions 622 or operating system 624), which may be executed by processing subsystem 610. For example, a ROM can store programs, utilities or processes to be executed in a non-volatile manner, and DRAM can provide volatile data storage, and may store instructions related to the operation of electronic device 600. Note that the one or more computer programs may constitute a computer-program mechanism, a computer-readable storage medium or software. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610. In some embodiments, the one or more computer programs are distributed over a network-coupled computer system so that the one or more computer programs are stored and executed in a distributed manner.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), such as: control logic 616, one or more interface circuits 618 and a set of antennas 620 (or antenna elements) in an adaptive array that can be selectively turned on and/or off by control logic 616 to create a variety of optional antenna patterns or ‘beam patterns.’ Alternatively, instead of the set of antennas, in some embodiments electronic device 600 includes one or more nodes 608, e.g., a pad or a connector, which can be coupled to the set of antennas 620. Thus, electronic device 600 may or may not include the set of antennas 620. For example, networking subsystem 614 can include a Bluetooth classic networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 614 includes one or more radios, such as a wake-up radio that is used to receive wake-up frames and wake-up beacons, and a main radio that is used to transmit and/or receive frames or packets during a normal operation mode. The wake-up radio and the main radio may be implemented separately (such as using discrete components or separate integrated circuits) or in a common integrated circuit.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting advertising or frame frames and/or scanning for advertising frames transmitted by other electronic devices.

Within electronic device 600, processing subsystem 610, memory subsystem 612 and networking subsystem 614 are coupled together using bus 628 that facilitates data transfer between these components. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc. Display subsystem 626 may be controlled by processing subsystem 610 to display information to a user (e.g., information relating to incoming, outgoing, or an active communication session).

Electronic device 600 can also include a user-input subsystem 630 that allows a user of the electronic device 600 to interact with electronic device 600. For example, user-input subsystem 630 can take a variety of forms, such as: a button, keypad, dial, touch screen, audio input interface, visual/image capture input interface, input in the form of sensor data, etc.

Electronic device 600 can be (or can be included in) any electronic device with at least one network interface. For example, electronic device 600 may include: a cellular telephone or a smartphone, a tablet computer, a laptop computer, a notebook computer, a personal or desktop computer, a netbook computer, a media player device, a wireless speaker, headphones, a keyboard, a mouse, a printer, another type of peripheral device, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 600, in alternative embodiments, different components and/or subsystems may be present in electronic device 600. For example, electronic device 600 may include one or more additional processing subsystems, memory subsystems, networking subsystems, and/or display subsystems. Additionally, one or more of the subsystems may not be present in electronic device 600. Moreover, in some embodiments, electronic device 600 may include one or more additional subsystems that are not shown in FIG. 6. In some embodiments, electronic device may include an analysis subsystem that performs at least some of the operations in the communication techniques. Also, although separate subsystems are shown in FIG. 6, in some embodiments some or all of a given subsystem or component can be integrated into one or more of the other subsystems or component(s) in electronic device 600. For example, in some embodiments program instructions 622 are included in operating system 624 and/or control logic 616 is included in the one or more interface circuits 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 614. This integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Bluetooth classic communication protocol as an illustrative example, in other embodiments a wide variety of communication protocols and, more generally, wireless communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 622, operating system 624 (such as a driver for an interface circuit in networking subsystem 614) or in firmware in an interface circuit networking subsystem 614. Alternatively or additionally, at least some of the operations in the communication techniques may be implemented in a physical layer, such as hardware in an interface circuit in networking subsystem 614. In some embodiments, the communication techniques are implemented, at least in part, in a MAC layer and/or in a physical layer in an interface circuit in networking subsystem 614.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An interface circuit, comprising:
circuitry configured to communicate using a Bluetooth communication protocol, wherein the circuitry is configured to support multiple independent virtual Bluetooth classic media access control (MAC) addresses, and wherein the circuitry is configured to:
identify an active session corresponding to a user or a user profile;
determine a virtual Bluetooth classic MAC address to be used for the active session, wherein the virtual Bluetooth classic MAC address is associated with the user or the user profile, and differs from a hardware MAC address associated with the circuitry; and
communicate a message to a second interface circuit, wherein the message comprises the virtual Bluetooth classic MAC address.

2. The interface circuit of claim 1, wherein, when the user or the user profile signs out of the interface circuit, the circuitry does not use the virtual Bluetooth classic MAC address for a subsequent message.

3. (canceled)

4. The interface circuit of claim 1, wherein, when the active session is terminated, the circuitry is configured to revert to communicating a subsequent message using a hardware Bluetooth classic MAC address corresponding to the interface circuit.

5. An electronic device, comprising:
an antenna node configured to communicatively couple to an antenna; and
an interface circuit, communicatively coupled to the antenna node, configured to communicate using a Bluetooth communication protocol, wherein the interface circuit is configured to support multiple independent virtual Bluetooth classic media access control (MAC) addresses associated with different users or different user profiles, and wherein the interface circuit is configured to:
communicate a message with a second electronic device, wherein the message is compatible with the Bluetooth communication protocol and comprises a virtual Bluetooth classic MAC address of the virtual Bluetooth classic MAC addresses associated with a user of the users or a user profile of the user profiles.

6. The electronic device of claim 5, wherein, while the user or the user profile is signed into the electronic device, the interface circuit is configured to solely communicate messages using the virtual Bluetooth classic MAC address.

7. The electronic device of claim 5, wherein, when the user or the user profile signs out of the electronic device and a second user or a second user profile signs into the electronic device, the interface circuit is configured to communicate a subsequent message using a second virtual Bluetooth classic MAC address of the virtual Bluetooth classic MAC addresses associated with the second user of the users or the second user profile of the user profiles.

8. The electronic device of claim 5, wherein, when a new user that is not included in the users or a new user profile that is not included in the user profiles signs into the electronic device, the electronic device is configured to:
associate a new virtual Bluetooth classic MAC address with the new user or the new user profile; and
provide, addressed to a computer, information specifying the new virtual Bluetooth classic MAC address associated with the new user or the new user profile.

9. The electronic device of claim 8, wherein program instructions executed by a processor in the electronic device or a Bluetooth controller in the electronic device are configured to assign the new virtual Bluetooth classic MAC address.

10. The electronic device of claim 8, wherein the new virtual Bluetooth classic MAC address is used with multiple electronic devices associated with the new user or the new user profile.

11. The electronic device of claim 5, wherein the interface circuit is configured to support performing discovery using the virtual Bluetooth classic MAC addresses.

12. The electronic device of claim 11, wherein the interface circuit is configured to support the performing of the discovery using different virtual Bluetooth classic MAC addresses at different times using time-division multiplexing of the supported virtual Bluetooth classic MAC addresses.

13. The electronic device of claim 5, wherein the electronic device is configured to personalize a configuration or one or more capabilities of the electronic device based at least in part on the user or the user profile.

14. The electronic device of claim 5, wherein the electronic device is configured to use a generic configuration or one or more generic capabilities of the electronic device for at least some of the users or at least some of the user profiles.

15. The electronic device of claim 5, wherein, when the user or the user profile signs out of the electronic device, the interface circuit is configured to revert to communicating a subsequent message using a hardware Bluetooth classic MAC address of the electronic device.

16. The electronic device of claim 5, wherein the electronic device is configured to solely allow pairing with electronic devices specified in a list of allowed electronic devices; and
wherein the list of allowed electronic devices is associated with the user or the user profile.

17. The electronic device of claim 5, wherein the interface circuit is configured to use the virtual Bluetooth classic MAC address when pairing with the second electronic device.

18. The electronic device of claim 5, wherein the interface circuit is configured to use a hardware Bluetooth classic MAC address of the electronic device when pairing with the second electronic device.

19. The electronic device of claim 5, wherein the virtual Bluetooth classic MAC address is associated with two or more of the users or two or more of the user profiles, and the interface circuit is configured to concurrently pair with and communicate using the virtual Bluetooth classic MAC address with electronic devices associated with the two or more of the users or the two or more of the user profiles.

20. The electronic device of claim 5, wherein the virtual Bluetooth classic MAC address is different from a hardware Bluetooth classic MAC address of the electronic device.

21. A method for communicating a message, comprising:
by an interface circuit, wherein the interface circuit supports multiple independent virtual Bluetooth classic media access control (MAC) addresses associated with different users or different user profiles:
communicating the message with a second electronic device, wherein the message is compatible with a Bluetooth communication protocol and comprises a virtual Bluetooth classic MAC address of the virtual Bluetooth classic MAC addresses associated with a user of the users or a user profile of the user profiles; and
when the user or the user profile signs out of the electronic device and a second user or a second user profile signs into the electronic device, communicating a subsequent message using a second virtual Bluetooth classic MAC address associated with the second user or the second user profile, wherein the second virtual Bluetooth classic MAC address is different from the virtual Bluetooth classic MAC address.
